(19) United States
(12) Patent Application Publication
(10) Pub. No.: US 2008/0238019 A1
(43) Pub. Date: Oct. 2, 2008

(54) Step apparatus for vehicle

(75) Inventors: Hiroki Okada, Okazaki-shi (JP); Ryoichi Fukumoto, Nagoya-shi (JP); Seiichi Suzuki, Nishikamo-gun (JP); Masayoshi Yasuhara, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/071,174

(22) Filed: Feb. 15, 2008

(30) Foreign Application Priority Data
Mar. 27, 2007 (JP) 2007-082862

(51) Int. Cl. B60R 3/02

(52) U.S. Cl. 280/166

(57) ABSTRACT

A step apparatus for a vehicle on which a passenger steps when ingressing to and egressing from the vehicle through an opening formed in a vehicle body, which includes a step panel provided at the opening to be closed or opened by a vehicle door movably supported on the vehicle body through a supporting member. The step panel disposed between a lower end portion of the opening and the supporting member.

### CROSS REFERENCE TO RELATED APPLICATIONS

This application is based on and claims priority under 35 U.S.C. §119 to Japanese Patent Application 2007-082862, filed on Mar. 27, 2007, the entire content of which is incorporated herein by reference.

### FIELD OF THE INVENTION

This invention generally relates to a step apparatus for a vehicle.

### BACKGROUND

Conventionally a vehicle such as a minivan is provided with a slide door on a side of the vehicle for ingress and egress of passengers to the vehicle. A guide rail is provided on an underside of a step panel to extend in a longitudinal direction of the vehicle. A vertical roller, which is rotatably housed in the guide rail, is provided on an end of a slide arm formed on a lower end of the slide door so as to project substantially perpendicular to the slide door. By moving the slide door along the guide rail, an opening for ingressing and egressing is opened and closed (refer to, for example, FIG. 2 disclosed in JP2006-327222B). Since a floor of the vehicle such as the minivan is positioned relatively higher than the ground surface, the step panel is provided at the platform so as to be one-step lower than the floor.

According to a structure disclosed in JP2006-327222B, in order to provide a fixed step inside a vehicle compartment where sealing is assured, the step panel must be disposed above an opening and closing mechanism of the slide door, thus still being relatively higher than the ground surface. Consequently, there is room for improvement regarding ease of ingress to the vehicle compartment for passengers such as infants or elderly people.

A need thus exists for a step apparatus for a vehicle, which is not susceptible to the drawback mentioned above.

### SUMMARY OF THE INVENTION

In light of the foregoing, the present invention provides a step apparatus for a vehicle on which a passenger steps when ingressing to and egressing from the vehicle through an opening formed in a vehicle body, which includes a step panel provided at the opening to be closed or opened by a vehicle door movably supported on the vehicle body through a supporting member. The step panel disposed between a lower end portion of the opening and the supporting member.

### BRIEF DESCRIPTION OF THE DRAWINGS

The foregoing and additional features and characteristics of the present invention will become more apparent from the following detailed description considered with reference to the accompanying drawings, wherein:

FIG. 1 is a plan view illustrating a step apparatus for a vehicle according to an embodiment when a slide door is in a fully opened position;

FIG. 2 is a cross-sectional view taken on line I-I of FIG. 1;

FIG. 3 is a plan view illustrating the step apparatus for the vehicle according to the embodiment when the slide door is in a fully closed position;

FIG. 4 is a cross-sectional view taken on line II-II of FIG. 2;

FIG. 5 is a cross-sectional view illustrating a movable step according to another embodiment;

FIG. 6A schematically illustrates an operation of the step apparatus for the vehicle according to the embodiment;

FIG. 6B schematically illustrates the operation of the step apparatus for the vehicle according to the embodiment;

FIG. 6C schematically illustrates the operation of the step apparatus for the vehicle according to the embodiment;

FIG. 6D schematically illustrates the operation of the step apparatus for the vehicle according to the embodiment;

FIG. 7 schematically illustrates a vehicle, such as an automobile, according to the embodiment; and

FIG. 8 is a cross-sectional view of a fixed step according to another embodiment.

### DETAILED DESCRIPTION

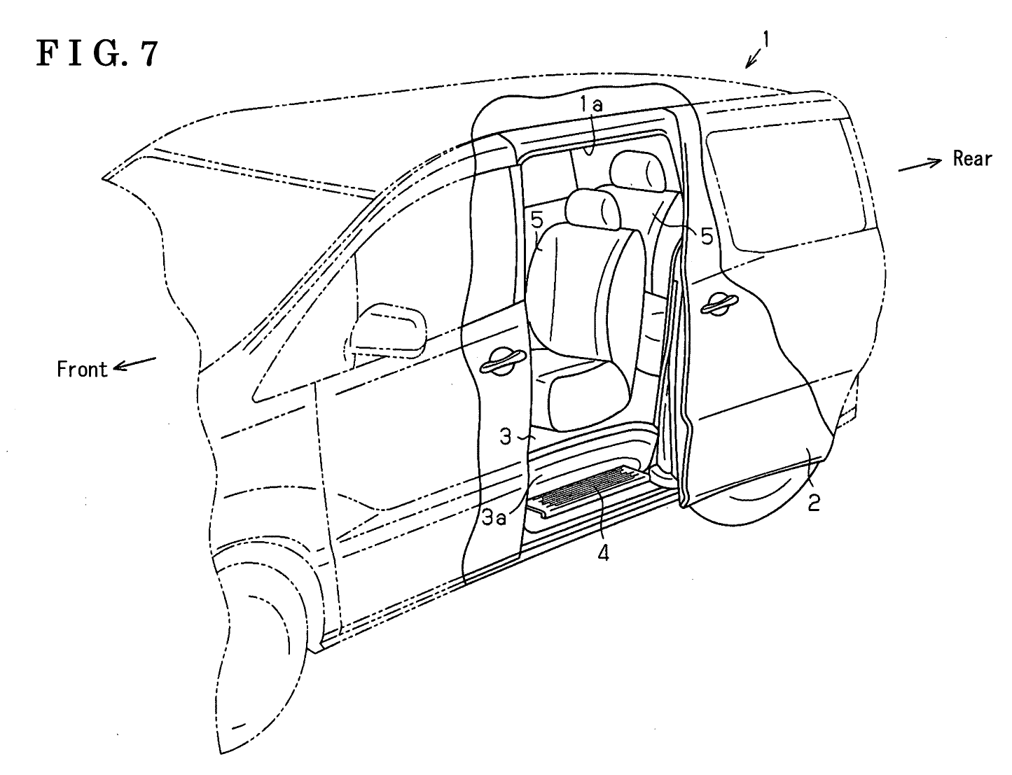

Preferred embodiments of the present invention are described in more detail below referring to the accompanying drawings. In the drawings, identical parts and members are designated by identical reference numerals. As shown in FIG. 7, a door opening 1a serving as an opening is formed on a side of a vehicle body 1. The door opening 1a is opened and closed by a slide door 2 serving as a vehicle door and moving in a longitudinal direction of the vehicle. A floor 3 of the vehicle is recessed toward a vehicle compartment relative to the door opening 1a to form a platform 3a. A movable step 4 serving as a movable step panel is provided at the platform 3a, the movable step 4 being projected or stored (i.e., moved) in a width direction of the vehicle, in a lower position than the floor 3. Seats 5 are provided on the floor 3, on a side and a back of the movable step 4 (the platform 3a) in the longitudinal direction of the vehicle.

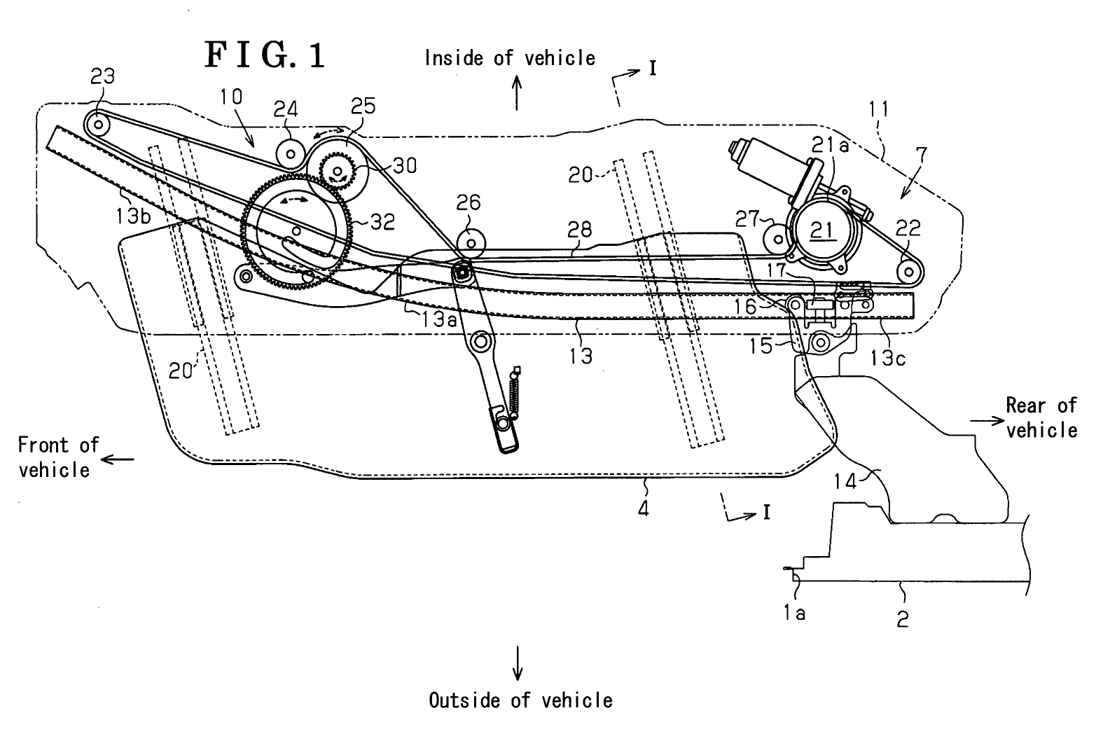

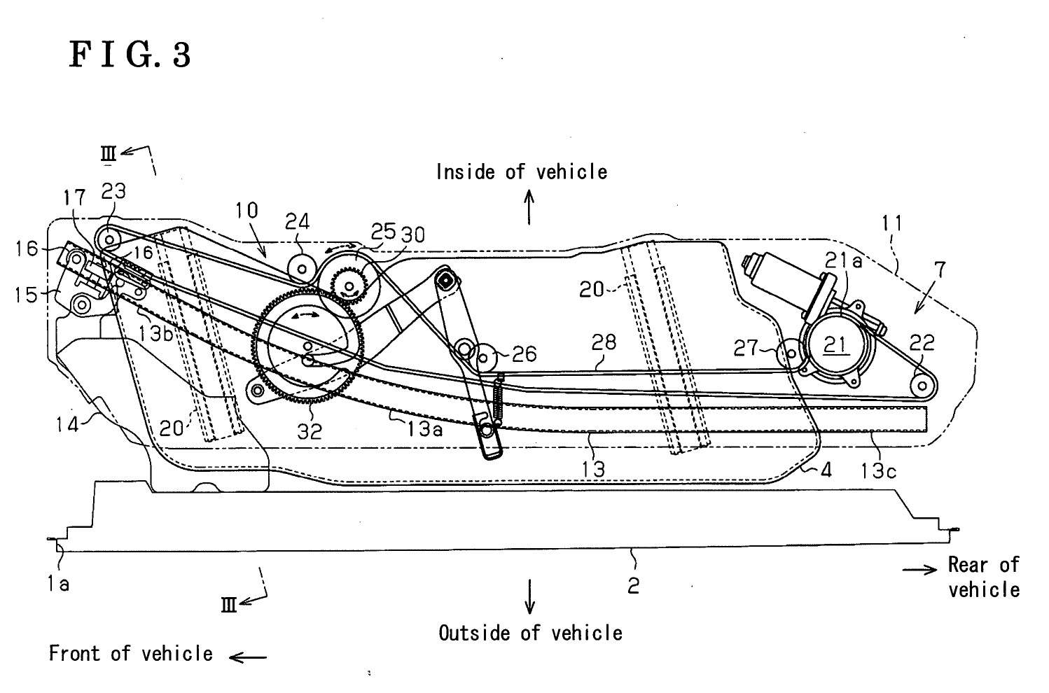

A detailed structure related to actuation of the slide door 2 for an open and close operation thereof and actuation of the movable step 4 for projecting or storing operation thereof is described referring to FIG. 1 to FIG. 4. In FIGS. 1 and 3, upward and downward directions of the drawings correspond to an inside and an outside of the vehicle in the width direction thereof respectively, and left and right directions of the drawings correspond to a front side and a rear side of the vehicle respectively. For an explanatory purpose, the movable step 4 and some other structure members are drawn with, for example, dotted lines so as to show the structure members beneath.

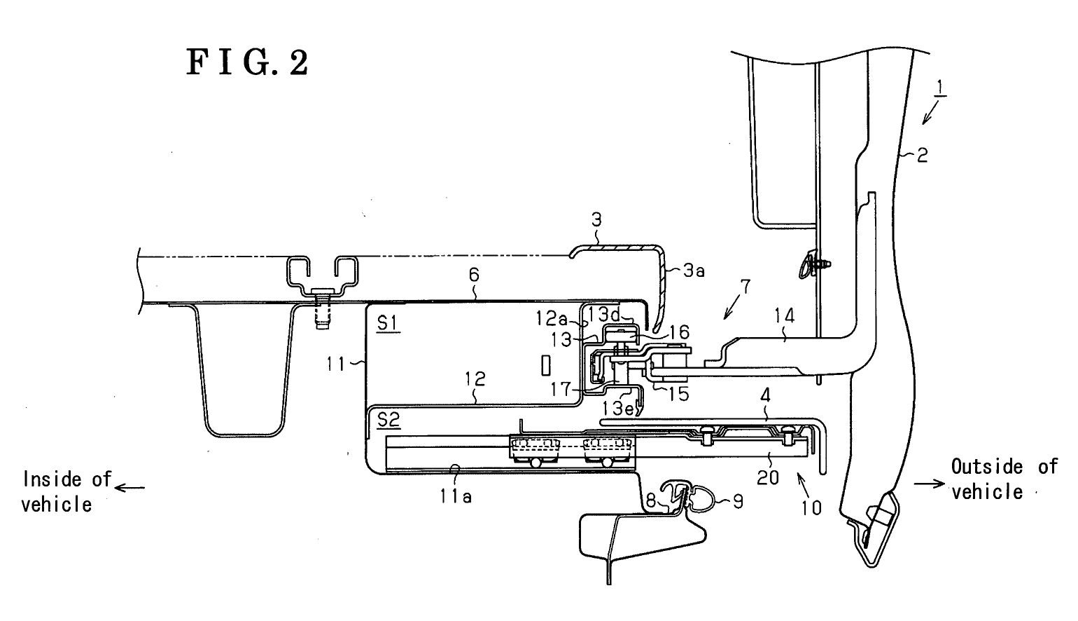

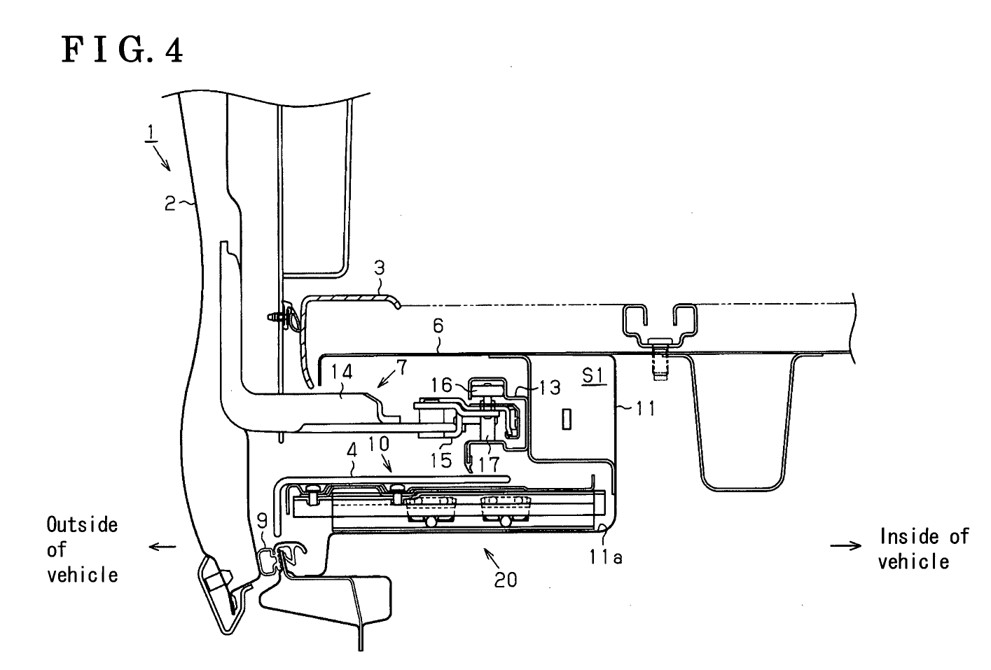

As shown in FIG. 2 and FIG. 4, a box-shaped case 11 (a step under panel) which is attached to a floor panel 6 provided under the floor 3 and which opens toward the outside of the vehicle is securely provided on the vehicle body 1. The case 11 forms a storage space S1 under the floor 3. A substantially L-shaped bracket 12 blocking the storage space S1 is fixedly provided to the case 11 so as to form a rectangle in cooperation with the case 11. The bracket 12 includes a portion for fixing a guide rail 13 inside the storage space S1. The guide rail 13 is provided on a side face 12a of the bracket 12 along the longitudinal direction of the vehicle body 1. A guide roller 16 (for example, a pair of guide rollers 16, 16) of the slide door 2 rotatably engages with an upper portion 13d of the guide rail 13 so that a movement of the slide door 2 in the width direction of the vehicle is restricted and so that a load roller 17 of the slide door 2 is rotatably supported at a lower portion 13e of the guide rail 13. With the above mentioned structure, a door opening and closing mechanism 7 serving as a first power transmission mechanism which opens and closes the slide door 2 is fixed on an intermediate portion of the case 11 in a height direction thereof.

The guide rail 13 is provided for guiding the open and close operation of the slide door 2. Specifically, the guide rail 13 includes a bent portion 13a in a longitudinally intermediate portion thereof as shown in FIG. 1. Further, the guide rail 13 includes a curved portion 13b being inclined inwardly in the width direction of the vehicle and extending to a forward of the vehicle from the bent portion 13a. Still further, the guide rail 13 includes a straight portion 13c extending in a rear direction of the vehicle from the bent portion 13a.

An arm 14 serving as a supporting member projecting inwardly in the width direction of the vehicle is provided on a lower portion of the slide door 2. A roller support member 15 is pivotably connected to an end portion of the arm 14. The roller support member 15 is provided with the pair of guide rollers 16, 16 and the load roller 17 disposed between the pair of guide rollers 16, 16. The pair of guide rollers 16, 16 have rotation axes extending in a height direction of the vehicle (i.e., in a direction perpendicular to the paper surface on which FIG. 1 is drawn), and the load roller 17 has a rotation axis extending in a direction perpendicular to a plane including the rotation axes of the pair of guide rollers 16, 16. In the storage space S1, the roller support member 15 is movably supported on the case 11 (i.e., on the vehicle body 1) by means of the load roller 17 in a condition in which the pair of guide rollers 16, 16 are rotatably mounted to the guide rail 13.

Consequently, the slide door 2 connected to the roller support member 15 via the arm 14 slides in the longitudinal direction of the vehicle by allowing the pair of guide rollers 16, 16 to be guided on the guide rail 13, thereby opening and closing the door opening 1a. A load of the slide door 2 is supported by means of the load roller 17. Specifically, for example, right after the slide door 2 starts an opening operation from a fully closed condition, the slide door 2 is pushed outward of the vehicle by allowing the pair of guide rollers 16, 16 to be guided by the guide rail 13 in the forward of the vehicle relative to the bent portion 13a (i.e., at the curved portion 13b). In addition, right before the slide door 2 reaches the fully closed condition, the slide door 2 is pulled inward of the vehicle in the same manner as described above. By this, the slide door 2 is allowed to slide in the rear direction of the vehicle during the opening operation and is positioned so that the slide door 2 and a side of the vehicle body 1 are arranged on a same surface when the slide door 2 is fully closed.

A mechanism for actuating the slide door 2 to be opened and closed is mounted to a bottom 11a of the case 11, in an area closer to the inside of the vehicle relative to the guide rail 13. More specifically, a slide door drive unit 21 serving as an electric drive source, plural idle gears 22, 23, 24, 25, 26 and 27, and a drive belt 28 are mounted to the bottom 11a of the case 11. The idle gears 22, 23, 24, 25, 26 and 27 are sequentially arranged in a clockwise direction starting from the slide door drive unit 21. The drive belt 28 is engagingly wrapped around an output gear 21a of the slide door drive unit 21 and around the idle gears 22, 23, 24, 25, 26 and 27. The guide rail 13, the arm 14, the pair of rollers 16, 16, the load roller 17, the idle gears 22, 23, 24, 25, 26 and 27, and the drive belt 28 constitute the door opening and closing mechanism 7 serving as the first power transmission mechanism.

The slide door drive unit 21 is fixed on the bottom 11a of the case 11 and rotates the output gear 21a. The idle gears 22, 23, 24, 25, 26 and 27 are rotatably supported by the case 11. The idle gears 23 and 22 are disposed near front and rear ends of the guide rail 13, respectively. The idle gear 25 is disposed in an intermediate portion between the idle gears 22 and 23, in the area closer to the inside of the vehicle relative to the guide rail 13. In addition, an appropriate idle gear (not shown) is disposed in the intermediate portion between the idle gears 22 and 23, which corresponds to the vicinity of the bent portion 13a, and the drive belt 28 is engaged with the appropriate idle gear.

An end portion of the roller support member 15 is fixedly connected to the drive belt 28 in a range between the idle gears 22 and 23 each disposed along the guide rail 13. When the slide door 2 is in a fully closed position as shown in FIG. 3, the end portion of the roller support member 15 is located near the idle gear 23, that is, near the front end of the guide rail 13. When the slide door 2 is in the fully opened position as shown in FIG. 1, the end portion of the roller support member 15 is located near the idle gear 22, that is, near the rear end of the guide rail 13.

In FIG. 3, when the output gear 21a is actuated to rotate counterclockwise by the slide door drive unit 21, the drive belt 28 moves in the rear direction of the vehicle between the idle gears 23 and 22 each disposed along the guide rail 13, while rotating the idle gears 22, 23, 24, 25, 26 and 27. At this time, the idle gear 25 rotates counterclockwise in FIG. 3. The slide door 2 connected to the drive belt 28 via the roller support member 15 and other structure members moves along the guide rail 13 in the rear direction of the vehicle to open the door opening 1a.

On the other hand, in FIG. 1, when the output gear 21a is driven to rotate clockwise by the slide door drive unit 21, the drive belt 28 moves in the front direction of the vehicle between the idle gears 22 and 23 while rotating the idle gears 22, 23, 24, 25, 26 and 27. At this time, the idle gear 25 rotates clockwise in FIG. 1. The slide door 2, which is connected to the drive belt 28 via the roller support member 15 and other structure members moves along the guide rail 13 in the front direction of the vehicle to close the door opening 1a.

The movable step 4 is supported under the door opening and closing mechanism 7 via rail members 20 serving as rails (refer to FIG. 1). More specifically, the movable step 4 is supported on the bottom 11a of the case 11 so as to slide in a direction slightly inclined at a predetermined angle relative to the vehicle's width direction (i.e., an inside-outside direction of the vehicle). As shown in FIG. 1, the rail members 20 are provided at both ends of the movable step 4 in the longitudinal direction of the vehicle.

A lower end of the case 11, more specifically, an edge of the door opening 1a is fastened to a rocker rail 8 by means of, for example, a screw. A sealing member 9 is attached to the rocker rail 8 along a longitudinal direction thereof for sealing between an inner surface of a lower edge of the slide door 2 and the vehicle body 1 when the slide door 2 is closed.

As described above, a space S2 is formed between the step under panel (i.e., the case 11) and the door opening and closing mechanism 7, which includes the guide rail 13, the arm 14, the pair of rollers 16, 16, and the load roller 17, by fixing the guide rail 13 between the floor panel 6 and the case 11 by means of the bracket 12. In addition, by providing a movable step mechanism 10 serving as a second power transmission mechanism, the step is positioned at the lowest position of the vehicle compartment where sealing is assured.

The movable step mechanism 10 is constituted by a gear 30 disposed above the idle gear 25 coaxially with the idle gear 25 and a disc shaped plate cam 32 engaged with the gear 30, each of which is rotatably supported on the bottom 11a of the case 11. The idle gear 25 causes the plate cam 32 to rotate or stop rotating based on torque transmitted to the gear 30, thereby projecting and storing the movable step 4 via the rail members 20.

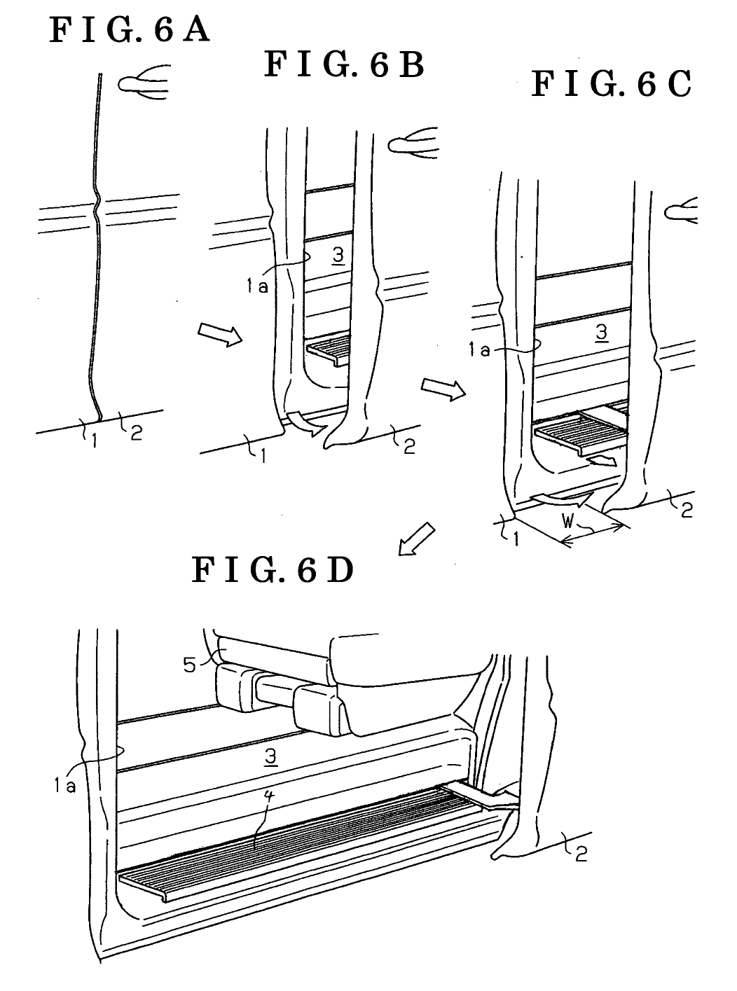

When the slide door 2 starts the opening operation (FIG. 6B) from the fully closed condition (FIG. 6A), torque is transmitted from the idle gear 25 to the plate cam 32, and at the same time, the movable step 4 starts to project. As shown in FIG. 6C, when an opening of the slide door 2 reaches a value W corresponding to a predetermined open position, the movable step 4 completes projection because the torque transmission to the plate cam 32 is stopped. When the slide door 2 continues the opening operation beyond the predetermined open position, the slide door 2 comes to be fully opened while the movable step 4 remains in the completely projected position (FIG. 6D). When the slide door 2 performs the closing operation from the fully opened condition, the slide door 2 and the movable step 4 operate in a substantially reverse order from the above described order.

As fully described above, the following effects are provided according to the embodiment. The movable step 4 is provided at the door opening 1a which is opened and closed by the slide door 2 so that the passenger can place his/her foot on the movable step 4 when ingressing or egressing the vehicle. The movable step 4 is disposed between a lower end portion of the door opening 1a and the arm 14 supporting the slide door 2.

According to the embodiment, the movable step 4 is disposed at the lowest position of the door opening 1a, which eases a first step of an ingress action to the vehicle, thus improving the ease of ingress to the vehicle. In addition, the movable step 4 is protected against dust or water since the movable step 4 is provided in the vehicle compartment where sealing is assured, thus preventing the movable step 4 from deteriorating.

According to the embodiment, the slide door 2 is opened and closed by a power transmitted thereto from the slide door drive unit 21 via the door opening and closing mechanism 7. The movable step 4 is movable in the width direction of the vehicle and provided with the movable step mechanism 10 for moving the movable step 4 by transmitting the power from the slide door drive unit 21 to the movable step 4.

By means of the slide door drive unit 21, the slide door 2, which may be heavy, is opened and closed with ease. Further, the movable step 4 is projected outside the vehicle in cooperation with the opening operation of the vehicle door 2 so as to be positioned at the lowest position of the vehicle compartment, thus improving the ease of ingress to and egress from the vehicle.

Furthermore, since the movable step 4 is stored under the floor 3 of the vehicle when the slide door 2 is closed, a gap between the slide door 2 and the floor 3 is eliminated, thus improving convenience and appearance.

The slide door drive unit 21 is used as the common drive unit to move the movable step 4 and the slide door 2. The movable step mechanism 10 moves the movable step 4 by means of the power transmitted from the slide door drive unit 21 via the door opening and closing mechanism 7. Since the two power transmission mechanisms use one common electric drive source as a power supply, the movable step 4 is provided with a simple structure.

The movable step 4 covers the sealing member 9 and protects it from being stepped on by an ingressing/egressing passenger when the slide door 2 is operated to open, thus preventing deformation of the scaling member 9 and sealing performance deterioration.

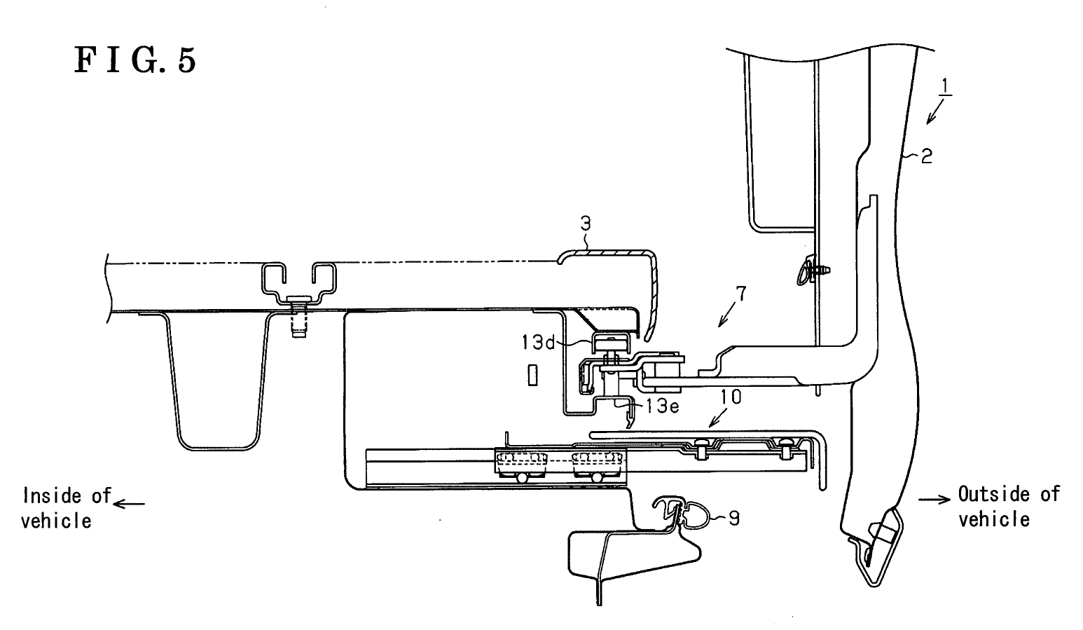

The above described embodiment can be modified as follows. Structures of the guide rail 13 and the door opening and closing mechanism 7 in the embodiment are examples. As shown in FIG. 5, the upper portion 13d and the lower portion 13e of the guide rail 13 may be separate guide rails each fixed on the floor panel 6. Further, an appropriate door opening and closing mechanism such as a link mechanism may be applied instead of the door opening and closing mechanism 7.

The structure of the door opening and closing mechanism 7 in the embodiment is an example. Any one or all of the output gear 21a, and the idle gears 22, 23, 24, 25, 26 and 27 may be replaced by one or more appropriate pulleys, for example.

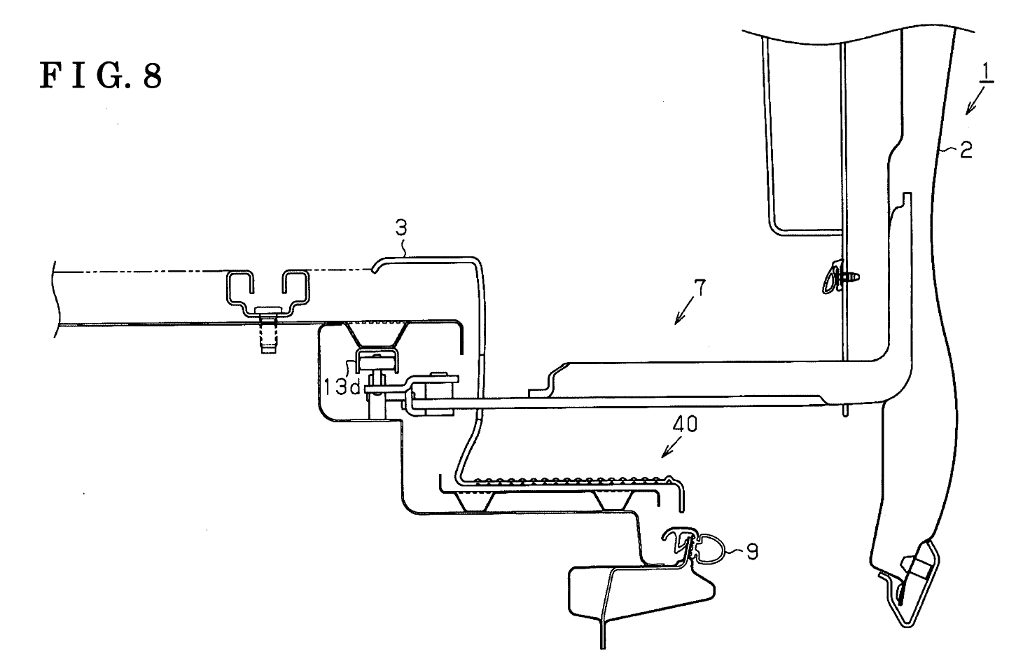

The movable step 4 is used for the step panel in the embodiment, however, a kicking plate 40 serving as a fixed step may be used as shown in FIG. 8.

The kicking plate 40 is fixed to the lower end portion of the door opening 1a so as to be lower than the floor 3 of the vehicle compartment. Consequently, the plate fixedly disposed at the lowest position in the vehicle body 1 improves the ease of ingress to and egress from the vehicle.

The slide door drive unit 21 is used as the common electric drive source to actuate the slide door 2 and the movable step 4 in the embodiment, however, separate electric drive sources may be applied.

Even without the power from the electric drive source, the movable step 4 is movable in cooperation with the opening and closing operation, for example, a manual operation of the slide door 2.

In the embodiment, the movable step 4 is applied to the vehicle provided with the slide door 2, however, the movable step 4 is also applicable to a vehicle having a door supported by means of a hinge serving as a supporting member provided at a front or a rear end of an opening.

The slide door 2 and the movable step 4 according to the embodiment are applicable to a vehicle which is unprovided with the slide door drive unit 21 or the door opening and closing mechanism 7.

According to the embodiment, the step apparatus for the vehicle is provided, which includes the step panel positioned at the lowest position of the vehicle compartment when the door of the vehicle is opened or closed.

According to the embodiment, the step apparatus for the vehicle includes the movable step 4 provided at the door opening 1a to be closed or opened by the slide door 2, on which the passenger steps when ingressing to and egressing from the vehicle, the movable step 4 being disposed between the lower end portion of the door opening 1a and the arm 14 supporting the slide door 2. Consequently, the movable step 4 is disposed at the lowest position of the door opening 1a, which eases the first step of an ingress action to the vehicle, thus improving the ease of ingress to the vehicle.

According to the embodiment, the movable step 4 moves in cooperation with the open and close operation of the slide door 2. Consequently, when the slide door 2 is moved manually or automatically according to a preference of the passenger, the movable step 4 is moved in cooperation with the operation of the slide door 2.

According to the embodiment, the slide door 2 is opened and closed by means of the power transmitted thereto from the slide door drive unit 21 via the door opening and closing mechanism 7 and the movable step 4 is the movable step panel which is movable in the width direction of the vehicle, the movable step 4 including the movable step mechanism 10 transmitting the power from the slide door drive unit 21 to the movable step 4 for moving the movable step 4. Consequently, the slide door 2, which may be heavy, is opened and closed without difficulty by means of the slide door drive unit 21. Further, the movable step 4 is projected outside the vehicle in cooperation with the opening operation of the slide door 2 so as to be positioned at the lowest position of the vehicle compartment, thus improving the ease of ingress to and egress from the vehicle.

According to the embodiment, the slide door drive unit 21 is used for moving the movable step 4 and for opening and closing the slide door 2. The door opening and closing mechanism 7 is connected to the slide door drive unit 21 and the movable step mechanism 10 is connected to the door opening and closing mechanism 7 in order to move the movable step 4. Consequently, one slide door drive unit 21 is used to supply power to the two power transmission mechanisms, thereby providing the movable step 4 with the simple structure.

According to the embodiment, the kicking plate 40 is the fixed step panel fixed on the lower end portion of the door opening 1a to be positioned lower than the floor 3 of the vehicle compartment. Consequently, the movable step 4 provided at the lowest position of the vehicle compartment improves the ease of ingress to and egress from the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A step apparatus for a vehicle on which a passenger steps when ingressing to and egressing from the vehicle through an opening formed in a vehicle body comprising:
a step panel provided at the opening to be closed or opened by a vehicle door movably supported on the vehicle body through a supporting member, the step panel disposed between a lower end portion of the opening and the supporting member.

2. The step apparatus for the vehicle according to claim 1, wherein the step panel moves in cooperation with an open and close operation of the vehicle door.

3. The step apparatus for the vehicle according to claim 1, wherein the vehicle door is opened and closed by means of power transmitted thereto from an electric drive source via a first power transmission device and wherein the step panel is a movable step panel which is movable in a width direction of the vehicle, the step panel including a second power transmission device transmitting the power to the step panel from the electric drive source for moving the step panel.

4. The step apparatus for the vehicle according to claim 3, wherein the electric drive source is used for moving the step panel and for opening and closing the vehicle door, and wherein the first power transmission device is connected to the electric drive source and the second power transmission device is connected to the first power transmission device in order to move the step panel.

5. The step apparatus for the vehicle according to claim 1, wherein the step panel is a fixed step panel fixed on the lower end portion of the opening to be positioned lower than a floor of a vehicle compartment.
